(19) United States
(12) Patent Application Publication
(10) Pub. No.: US 2009/0312959 A1
(43) Pub. Date: Dec. 17, 2009

(54) SYSTEM AND METHOD FOR MEASURING TORQUE IN ROTATING SHAFTS

(76) Inventor: Kurt L. BORMAN, Barboursville, VA (US)

Correspondence Address: BIRCH STEWART KOLASCH & BIRCH, PO BOX 747, FALLS CHURCH, VA, 22040-0747, US

(21) Appl. No.: 12/522,099

(22) PCT Filed: Jan. 3, 2008
(86) PCT No.: PCT/US2008/050125

§ 371 Date: Jul. 2, 2009

Related U.S. Application Data
(60) Provisional application No. 60/878,060, filed on Jan. 3, 2007.

(51) Int. Cl. G01L 3/04

(52) U.S. Cl. 702/41

(57) ABSTRACT

A system and method for measuring torque transmitted in a rotating shaft using two target devices located at separate locations on the shaft is disclosed. Each target device includes one or more reference edges, with two sensors each disposed adjacent to corresponding target device. A processor calculates, with reference to a counter, the difference between the clock times of successive reference edges to produce an actual time elapsed between the passages of the referenced edges by their respective sensors. The processor converts the change in time difference into a value that represents a change in the angular orientation of the two target devices with respect to their angular orientation at zero torque, which is substantially equivalent to an angle of twist in the rotating shaft between the target devices, and the processor calculates the torque transmitted in the rotating shaft based on the change in angle of twist.

### CROSS-REFERENCE

This application claims the benefit of U.S. provisional Application, Ser. No. 60/878,060 filed Jan. 3, 2007.

### TECHNICAL FIELD

The present invention relates generally to the measurement of torque transmitted by a rotating shaft. It particularly relates a system, method, and a computer readable medium for measuring the amount of twist induced in a rotating shaft of known stiffness over a known stressed section length, from which the torque can be calculated.

### BACKGROUND OF THE INVENTION

Currently, various means are used for measuring torque in a rotating shaft, including strain gauges placed directly on the shaft itself and communicating signals to a non-rotating fixture by means of slip rings, magnetoelastic sensors, as well as others. One other approach, for example, is a means for configuring toothed rings, optical targets, or other devices to rotate with a shaft which may by their passage cause a fixed sensor situated so as to view them to change the state of its electrical output in a predictable way with their passage. With suitable signal conditioning these electrical outputs may be reduced to a pulse train and with two such rotating target devices fixed to the shaft a known distance apart the relative time between the electrical signal transitions from the sensors may be detected, and with reference to the speed of rotation of the shaft transformed into the angular displacement or twist between them, which in turn will be proportional to the torque transmitted.

Various error sources may cause inaccurate calculation of torque in the above-mentioned measurement process. For example, error sources may arise in such a measurement process depending upon the details of the sensing devices and the calculation method used. One such common error source may be the variation in rise time of the sensor signals with shaft speed, ambient temperature of the sensor, component aging or other similar effects. These error sources affect the detection of the target devices which cause inaccurate torque measurement.

Therefore, due to the disadvantages mentioned above, there is a need to provide a system and method that provides an accurate measurement of torque in a rotating shaft in which the above-mentioned errors have been correctly accounted for in the calculation of the torque.

### SUMMARY OF THE INVENTION

The system and method of the present invention overcome the previously mentioned problems by calculating a twist of a rotating shaft and associated torque directly in a digital data processor, using timing information obtained from a sensor whose signal transitions are timed by a continuously counting digital clock.

According to one embodiment of the present invention, a system for measuring torque transmitted in a rotating shaft subject to torsional twist is disclosed. The system uses two target devices located at two locations on the shaft, each including one or more reference edges, with two sensors each disposed adjacent to corresponding target device for determining the passage of corresponding reference edge at each location during the rotation of the shaft and generating an electrical signal whose value is altered as the reference edges pass the sensor. A counter associated with each sensor produces a count value representative of the time between the passing of the reference edge and a counter reset, wherein the counters are reset in a known relationship. A processor calculates a difference between the clock times of successive reference edges to produce an actual time elapsed, with reference to the counter, between the passages of the referenced edges by their respective sensors, wherein a change in time difference represents a time proportional to twice the twist of the shaft as a consequence of transmitted torque. The processor converts the change in time difference into a value that represents a change in the angular orientation of the two target devices with respect to their angular orientation at zero torque, which is substantially equivalent to an angle of twist in the rotating shaft between the target devices, and the processor calculates the torque transmitted in the rotating shaft based on said change in angle of twist.

According to one embodiment of the present invention, a method is disclosed for measuring torque transmitted in a rotating shaft subject to torsional twist using two target devices located at two locations on the shaft, each including one or more reference edges, with two sensors each disposed adjacent to corresponding target device for determining the passage of corresponding reference edge at each location during the rotation of the shaft and generating an electrical signal whose value is altered as the reference edges pass the sensor. The method comprising the steps of producing a count value representative of the time between the passing of a said reference edge and a counter reset, said counters being reset in a known relationship, calculating a difference between the clock times of successive reference edges to produce an actual time elapsed between the passages of the referenced edges by their respective sensors, wherein a change in time difference represents a time proportional to twice the twist of the shaft as a consequence of transmitted torque, converting the change in time difference into a value that represents a change in the angular orientation of the two target devices with respect to their angular orientation at zero torque, which is substantially equivalent to an angle of twist in the rotating shaft between the target devices, and calculating the torque transmitted in the rotating shaft based on said change in angle of twist.

According to one embodiment of the present invention, a computer readable storage medium having stored thereon computer executable program is disclosed for measuring torque transmitted in a rotating shaft subject to torsional twist using two target devices located at two locations on the shaft, each including one or more reference edges, with two sensors each disposed adjacent to corresponding target device for determining the passage of corresponding reference edge at each location during the rotation of the shaft and generating an electrical signal whose value is altered as the reference edges pass the sensor. The computer program when executed causes a processor to execute steps of producing a count value representative of the time between the passing of a said reference edge and a counter reset, said counters being reset in a known relationship, calculating a difference between the clock times of successive reference edges to produce an actual time elapsed between the passages of the referenced edges by their respective sensors, wherein a change in time difference represents a time proportional to twice the twist of the shaft as a consequence of transmitted torque, converting the change in time difference into a value that represents a change in the angular orientation of the two target devices with respect to their angular orientation at zero torque, which is substantially equivalent to an angle of twist in the rotating shaft between the target devices, and calculating the torque transmitted in the rotating shaft based on said change in angle of twist.

According to an aspect of the claimed invention, the target devices may include axially or radially disposed toothed discs or wheels at separate locations on the shaft.

In contrast to torque measuring systems or methods described in the prior art, the present invention does not require that the teeth or other target devices on the rotating shaft be evenly spaced, symmetrical, or equal in number. The system and method disclosed herein employs only the rising edges (or, if desired, only the falling edges) of the signals generated by sensors in calculation of the angle of twist of the rotating shaft. Therefore, the torque calculation system and method of the instant invention is inherently insensitive to variations in tooth width, and the width of the teeth may be intentionally varied to encode any desired information.

The present invention also offers the possibility that existing gears that are already incorporated into machinery which the shaft drives, or from which it is driven, may be used as one or both of the rotating target devices, regardless of the number and spacing of their teeth. The ability to adapt existing gears into usable target devices by ignoring certain teeth in a pattern chosen to create a ‘virtual’ interrupter disc with fewer teeth is particularly useful if the maximum torque in the shaft will cause it to twist by more than the angular spacing of the existing gear teeth.

According to an aspect of the present invention, accurate torque measurement may still be performed even if the above-mentioned virtual interrupter disc includes an irregular and inconsistent spacing of its virtual teeth.

The present invention also allows for the incorporation of other pre-existing timing elements that may be inherent in the device powering the shaft's rotation, or in the load driven by it, to serve as one or both of the devices generating discrete signal transitions at known circumferential locations on the shaft, from which its twist and hence the torque transmitted by it may be calculated.

According to an aspect of the present invention, compensation for changes in the shaft stiffness with temperature may be made directly in a digital processor calculation, using only data from a temperature sensor applied along with the fundamental properties of the shaft's material.

According to an aspect of the present invention, the system and method may be utilized by varying the width and/or the spacing of the teeth on one or more of the toothed rings in order to encode any other useful information, such as an absolute index position (starting point or zero degree point).

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1 is a block diagram of a general purpose system in accordance with embodiments of the present invention.

FIG. 2 illustrates a typical arrangement of two toothed discs fixed to a shaft at known distance d apart, with a sensor at each disc generating an electrical signal indicative of the passage of each tooth.

FIG. 3 illustrates a typical arrangement wherein two sets of axially disposed teeth are fixed to the shaft at a practical distance apart but interleaved by virtue of an extended sleeve so that a single sensor and signal conditioning path can serve for both sets of teeth.

FIG. 4 shows an arrangement of FIG. 2 modified by adding additional teeth to the discs and rotating one of them by 45 degrees with respect to the other as configured in the zero torque condition, so that the teeth are alternately interleaved when their passage with rotation of the shaft is viewed in a time domain even when no torque is being transmitted.

FIG. 5 shows a flow diagram illustrating operations performed by a torque measuring system according to an embodiment of the present invention illustrated in FIGS. 1 and 4.

FIG. 6 illustrates an arrangement of the two symmetrically interleaved discs of FIG. 4 as viewed axially and also their sensor electrical outputs viewed as a function of time over one revolution of the shaft, both separately and in interleaved form.

FIG. 7 illustrates an arrangement similar to FIG. 6 but shows the angular relationship and sensor output as it would appear with a torque sufficient to cause 10 degrees of twist being transmitted by the shaft.

FIG. 8 illustrates a functional block diagram to implement interrupt service routine in according to an embodiment of the present invention.

FIG. 9 illustrates a more detailed time line of the interrupt service routine during a time span of one shaft revolution in according to an embodiment of the present invention illustrated in FIG. 8.

FIG. 10 illustrates an arbitrary pattern of tooth widths in according to an embodiment of the present invention.

FIG. 11 illustrates an arrangement similar to FIG. 6, except that a static alignment of the toothed discs at zero torque has been intentionally offset to an asymmetrical state in according to an embodiment of the present invention.

FIG. 12 illustrates an arrangement similar to FIG. 11, but shows a disc alignment and signal output when a torque sufficient to cause 5 degrees of twist is being transmitted by the shaft in which the torque is exerted in a same direction as the motion of the shaft.

FIG. 13 illustrates an arrangement similar to FIG. 11, but shows a disc alignment and signal outputs when a torque of similar magnitude but acting in a direction opposite to the shaft's rotation is being transmitted.

FIG. 14 illustrates how an existing gear inherent in machinery may also be used as a target disc element in a torque measurement system implemented according to an embodiment of the present invention.

FIG. 15 illustrates a gear element tooth disc shown in FIG. 14 and its companion disc in same axial and temporal views.

FIG. 16 illustrates a calculation method used when down-selecting virtual teeth in according to an embodiment of the present invention illustrated in FIGS. 14 and 15.

FIG. 17 illustrates an arrangement similar to FIG. 15, but illustrates how a minor change to a placement of the teeth on an added target disc element may aid the initialization process when using an existing gear as the other target disc element according to an embodiment of the present invention.

FIG. 18 shows another example of down-selection of virtual teeth, wherein both discs are implemented from existing gear elements.

FIG. 19 illustrates a functional block diagram that shows in form similar to FIG. 8 how the first revolution of the shaft in such an implementation would be implemented in according to an embodiment of the present invention.

FIG. 20 illustrates a functional block diagram to implement ring buffer interrupt service routine in according to an embodiment of the present invention after the initialization process has completed.

### DETAILED DESCRIPTION

The following detailed description of the embodiments of the invention refers to the accompanying drawings. The following detailed description does not limit the invention. Instead, the scope of the invention is defined by the appended claims and equivalents thereof.

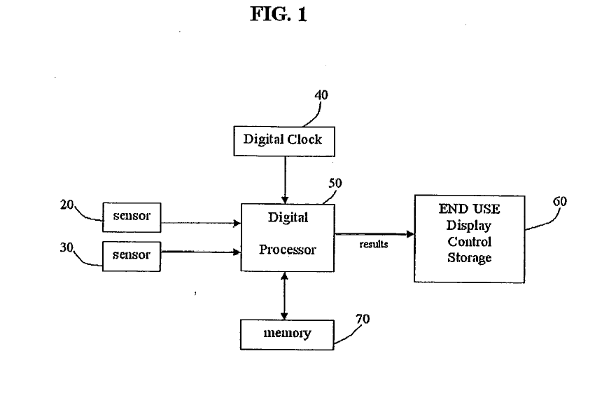

FIG. 1 illustrates a general purpose system 10 that may be utilized to perform the methods and algorithms disclosed herein. The system 10 shown in FIG. 1 includes Input/Output (I/O) devices sensor 20 and sensor 30, a digital clock 40, a digital processor 50, a display 60, and a memory 70. This system and particularly the digital processor 50 may be specially constructed for the inventive purposes such as a programmed digital signal processor (DSP), an application specific integrated circuit (ASIC), a field programmable gate array (FPGA) or special purpose electronic circuit, or it may comprise a general-purpose computer selectively activated or reconfigured by a computer program stored in the memory 70. Such a computer program may be stored in the memory 70, which may be a computer readable storage medium, such as, but is not limited to, any type of disk (including floppy disks, optical disks, CD-ROMs, and magnetic-optical disks) or solid-state memory devices such as a read-only memory ROM, random access memory (RAM), EPROM, EEPROM, magnetic or optical cards, or any type of computer readable media suitable for storing electronic instructions.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description herein. In addition, the present invention is not described with reference to any particular programming language. It will be appreciated that a variety of programming languages may be used to implement the teachings of the invention as described herein.

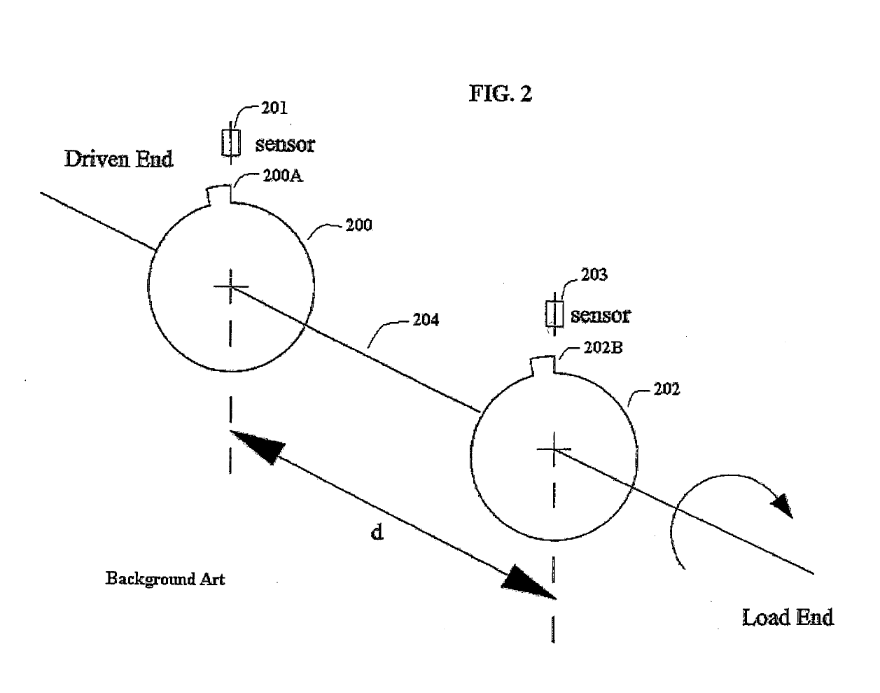

FIG. 2 illustrates a typical arrangement of two toothed target discs 200, 202 on a shaft 204, fixed at a known axial separation d which defines the length of the stressed section between the discs 200, 202 which together with the shaft's stiffness determines what angular change in the relative orientation of the two discs 200, 202 will result from any given torque transmitted by the shaft 204. In this typical arrangement, disc 200 is located nearer to the driven end of the shaft 204 and sensor 201 senses the rotational change of disc 200. Disc 202 is located nearer to the load end of the shaft 204 and sensor 203 senses the rotational change of disc 202. Disc 200 also includes a single tooth 200A and disc 202 includes a single tooth 202B.

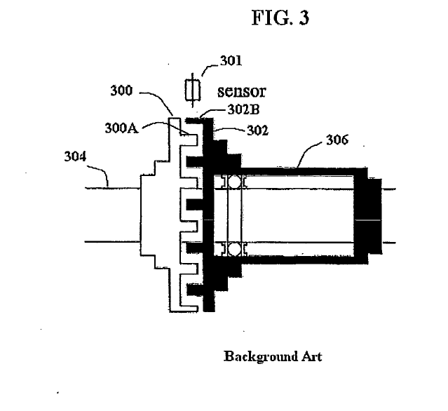

FIG. 3 illustrates another typical arrangement in which two sets of axially disposed teeth 300A, 302B are fixed to a shaft 304 at a practical distance apart but interleaved by virtue of an extended sleeve 306 with internal diameter greater than that of the shaft 304 so that a single sensor 301 and signal conditioning path can serve for both sets of teeth 300A, 302B. Teeth 300A are located on disc 300 and teeth 302B are located on disc 302. According to this arrangement, the sensor 301 senses the passing teeth 300A or 300B and produce a signal whose mark-space ratio could be conditioned with an analog circuitry (not shown) to produce a signal suitable to drive a display.

In the system and method according to an embodiment of the present invention either of the mechanical arrangements illustrated in FIGS. 2 and 3 may be used. In a case of that shown in FIG. 2, the present invention offers the further possibility that after signal conditioning the output from the two separate sensors 201, 203 may either be treated separately with two input channels of the digital processor 50 employed, or in some applications may be combined with a simple logic gate (not shown) so as to be serviced by a single channel in the digital processor 50 as though the teeth 300A located on disc 300 and the teeth 302B located on disc 302 were interleaved under a single sensor 301 as shown in FIG. 3. Once reduced to a digital logic level by a signal conditioning circuitry, a simple OR or NAND gate may be used to effect the mixing, depending on whether the result of the signal conditioning process produces active-high or active-low signals.

It will be understood by those experienced in the art that the specific detail design and arrangement of the toothed discs 300, 302 or other target devices used may take into account the maximum torque that will be transmitted in the shaft 304, the stiffness of the shaft 304, and the necessity that the maximum torque is not sufficient to cause the teeth 300A, 302B or other target devices to overlap. For example, the interleaved configuration shown in FIG. 3 the twist of the shaft 304 may never be sufficient to cause the teeth 300A, 302B to mechanically collide.

Further, in the configuration shown in FIG. 2, the twist of the shaft 204 may never be sufficient for the sensor signal generated by the sensor 201 from disc 200 indicating the passage of a target device to overlap with the sensor signal generated by sensor 203 from disc 202 in such a way as to cause the loss of a falling edge between the end of one tooth's passage under a sensor and a rising edge at the beginning of the passage of the next tooth under the sensor in the combined signals. If using separate channels to process the individual sensor outputs with reference to only their rising edges, or with reference to only their falling edges, then in fact it is only necessary to insure that the edges used do not overlap. In this case overlap will occur only when the twist is such that two consecutive signals from one target disc are generated without an intervening signal from a tooth on the other disc occurring between them.

The digital clock rate used to time the passages of the teeth 300A, 302B are chosen based on a required precision of the final twist measurement, taking into account the speed range over which the shaft 304 may rotate and the precision required in the torque measurements produced. In a case of very slow shaft speeds, the counter of the digital clock 40 shown in FIG. 1 may overflow multiple times between the passages of successive teeth, while in a case of very high speeds, the resolution of target position and hence torque is substantially limited by the granularity of the digital clock 40 as it times the passage of the teeth 300, 302B or other target devices on the discs 300, 302.

To some extent the above-mentioned considerations may be dealt with by straightforward digital processor programming methods familiar to those experienced in the art. For instance, clock overflows may be counted, and indeed many microprocessors are able to generate an interrupt at clock overflow. If, for instance, a 16 bit clock's overflow is counted in another 16 bit register, it in effect forms the high order 16 bits of a 32 bit clock, greatly extending the time period of the slowest revolution which may be handled without an error.

Other schemes are also possible, but a further teaching of this invention is that a fixed clock rate may be inconvenient when the machinery in question operates over a wide range of speeds, and in fact a scheduled system of clock speed changes may be implemented, triggered by the shaft speed passing from one pre-defined speed range into the next higher or lower one. If the clock in question is a software configurable device devoted exclusively to the torque measurement algorithm then software can change the clock rate as required, also changing related constants in the calculation program accordingly. If the clock rate used is inherently fixed, or must remain fixed due to other system uses, but is fast enough to suit the highest shaft speeds anticipated then a scheme for lowering the clock rate in software can be implemented by right-shifting some number of low-order bits out of each clock reading on a similar predetermined schedule as a function of shaft speed.

It is to be understood that in the entirety of the description of the invention the word ‘tooth’ is used consistently to mean a discrete edged appendage, application, marking, or area inset into or fixed on to the surface of a rotating shaft or appendage fixed thereto, whose passage is detected by a sensor which generates an electrical signal at times corresponding in a known way to the passage of a target device by the sensor.

It may be an unstressed mechanical tooth specifically included for the purpose of the torque measurement system and similar to those used for simplicity of illustration in the figures of this disclosure. But, it may also be any other element which performs an identical function when coupled with a sensor whose output is suited to the sensing function described herein. Thus, it could be an area of high optical reflectivity interspersed between areas of low optical reflectivity, or of high optical density interspersed with areas of transparency, in either case disposed to suit an optical sensing device.

Alternatively, it could be discrete amounts of ferrous or magnetic materials set into a rotating nonferrous disc and suitable to be detected by a Hall Effect or other sensor devices. Or, it may be any other discrete target element used to actuate a sensor employed to detect its passage and generate an electrical signal with transitions which occur with a known relationship in time to that passage.

It is a further teaching of this invention, described in detail later, that it may also be a functional, stressed gear element pre-existing in machinery for the transmission of power or motion.

Types of sensor which cause a stable and continuous digital change in their output may be chosen in implementing the present invention so long as the presence of a target device with appropriate characteristics remains within their specified field of view. Such sensors may include Hall Effect devices and other similar sensor devices which cause a stable and continuous digital change in their output. These devices produce a stable change of state in their electrical output with the passage of an appropriate triggering device into their field of view (rising edge), and a similar stable change of state when the triggering device leaves their field of view (falling edge). They are sometimes referred to as zero-speed sensors, since their output is not contingent on motion of the triggering device. As used herein, rising edge refers to the change of state that occurs in their output signal when a target device is detected, and falling edge refers to the change of state that occurs in their output when a target device exits their field of view. It will be understood that the sensors may be active-high or active-low devices, and in the latter case their electrical output will fall at the rising edge and rise at the falling edge.

Other useful sensor types, most notably variable reluctance sensors, are dynamic in the sense that they produce no output without motion of the target device within their field of view. It is also the case that their output is analog in nature and varies with the speed of passage of the target devices, over a very large range in the case of variable reluctance sensors. Nonetheless, variable reluctance sensor types are useful in many applications which require a sensor to operate in areas of high temperature, and they may also be used in a system such as that disclosed herein so long as appropriate signal conditioning is applied. It is generally accepted that the most appropriate signal conditioning for variable reluctance sensor output in a timing application such as that discussed herein is the zero crossing of its bipolar output signal, which occurs at the midpoint of the passage of ferrous material through its field of view. According to an embodiment of the present invention, this would generally correspond to the mid-point of a ferrous tooth. Conditioned with an appropriate zero-crossing detector, the sensor types disclosed above may function adequately in the context of the invention disclosed herein, but it will be understood that an output of a zero crossing detector acting on such a sensor's signal generates only a single meaningful edge, corresponding not to the mechanical rising or falling edge of the tooth but to its midpoint.

Moreover, according to an aspect of the present invention, the target devices and sensor types need not be of the same type for the two discs which comprise the target elements in a system such as disclosed herein. If, for instance, it is convenient for one or more of the target disc elements to be an actual stressed mechanical gear element already present in the machinery, according to an embodiment of the present invention, a variable reluctance sensor may be used in that environment, yet another type of target disc viewed by another type of sensor may be its partner at another location on the shaft.

Stressed gears are likely to operate in relatively harsh and high temperature environments more tolerable to variable reluctance sensor types. Such gears are also certain to contain evenly spaced, equal width teeth from which a zero-crossing detector can reliably generate signals.

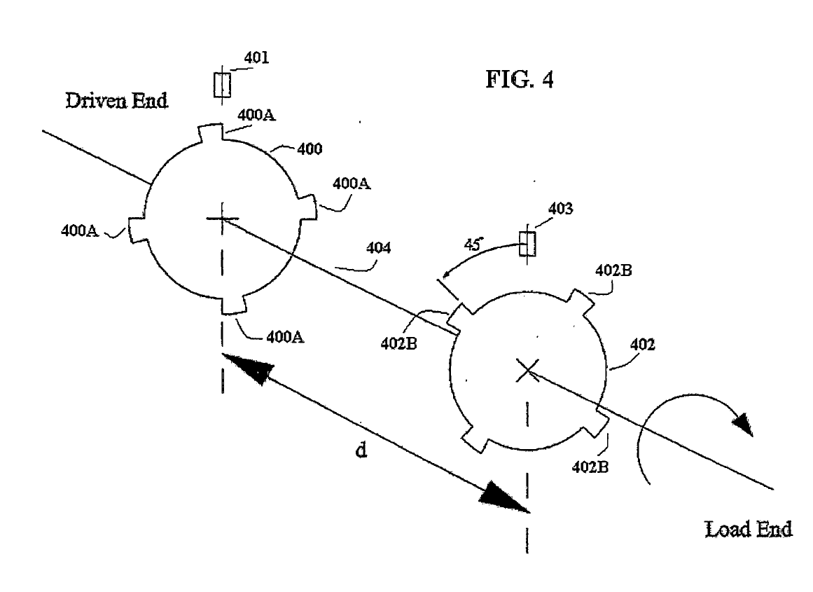

FIG. 4 shows an arrangement of FIG. 2 modified by adding additional teeth to the discs and rotating one of them by 45 degrees with respect to the other, so that the teeth are alternately interleaved when their passage with rotation of the shaft is viewed in a time domain even when no torque is being transmitted. Advantageously, disc 400 includes teeth 400A radially disposed at the periphery of disc 400. Sensor 401 is used to generate electrical signal as it detects passage of the teeth 400A. Disc 402 includes teeth 402B radially disposed at the periphery of disc 402. Sensor 403 is used to generate electrical signal as it detects passage of the teeth 402B. Disc 400 is located nearer to the driven end of the shaft 404 and disc 402 is located nearer to the load end of the shaft 404.

As shown in FIG. 4, the relative orientation of the target discs 400, 402 at zero torque has been altered by rotating the disc 402 nearest to the load end by 45 degrees. The intended result of this is to ensure that at all times the teeth 400A, 402B or target devices of the two discs 400, 402 are interleaved, so that the passage of the teeth 400A by their sensor 401 is always followed by the passage of teeth 402B by their sensor 403.

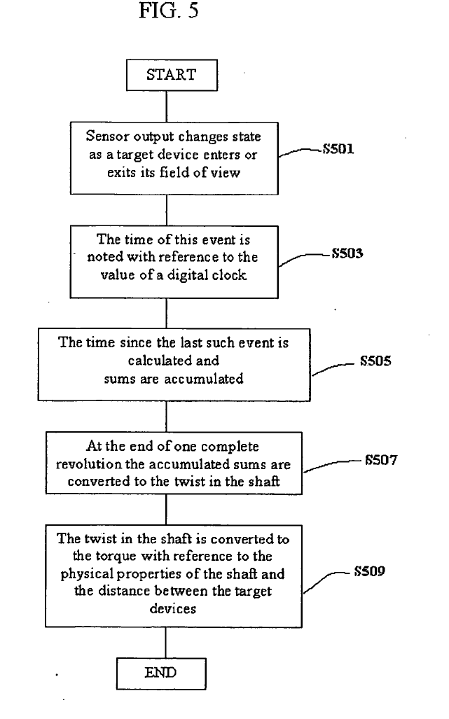

FIG. 5 shows a flow diagram illustrating operations performed by a torque measuring system according to an embodiment of the present invention illustrated in FIGS. 1 and 4. At step S501, sensor outputs from sensors 401 and 403 change state as a target disc 400 or 402 enters or exists the sensors' 401, 403 field of view. Accordingly, the passage of target discs 400, 402 at each location during the rotation of the shaft 404 is determined by generating an electrical signal whose value is altered as the target devices 400, 402 enter or exit the sensors' 401, 403 field of view, respectively. At step S503, the event when the sensor output changes state is recorded with reference to the digital clock 40 shown in FIG. 1. At step S505, the time since the last such event is calculated and sums are accumulated. In other words, the digital clock 40 shown in FIG. 1 is used for timing the occurrence of the altered value of the electrical signal at step S503 and calculating relative times of passage of the target discs 400, 402 sensed by the sensors 401, 403, respectively at step S505. At step S507, the digital processor 50 shown in FIG. 1 is used to convert the relative times to a change in orientation of the two target discs 400, 402 which is substantially equivalent to an angle of twist in the rotating shaft 404 between the target discs 400, 402 at the end of one complete revolution. At step S509, the digital processor 50 calculates the torque transmitted in the rotating shaft 404 based on the angle of twist, physical properties of the shaft 404, and the distance between the discs 400, 402.

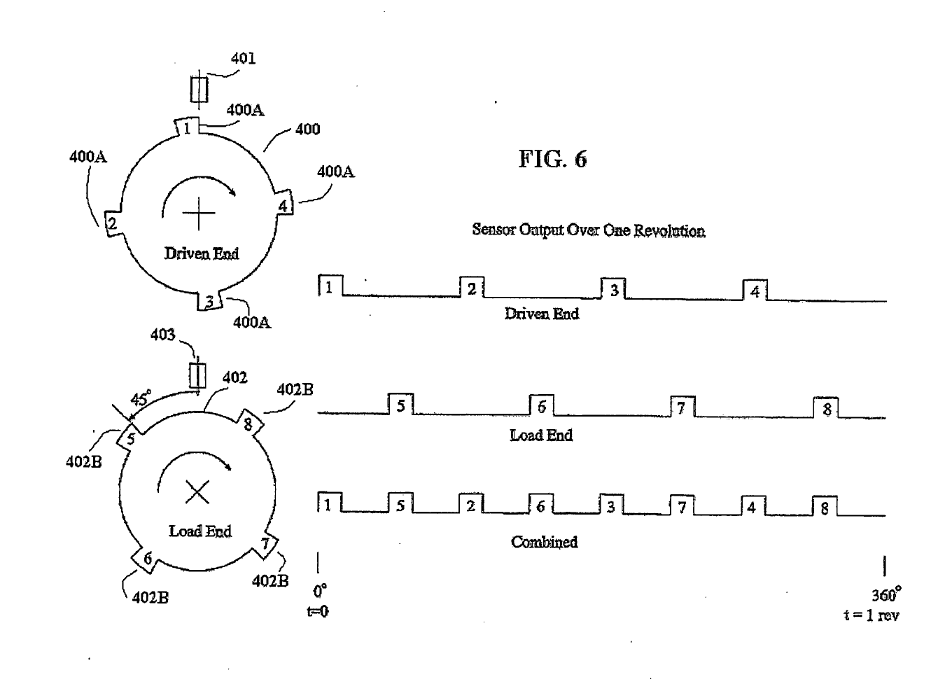

FIG. 6 illustrates an arrangement of the two symmetrically interleaved discs 400, 402 of FIG. 4 as viewed axially and also their sensor 401, 403 electrical outputs viewed as a function of time over one revolution of the shaft 404, both separately and in interleaved form. FIG. 6 also shows the signals on a common time line as they would look if combined by a logic gate or generated by axially oriented teeth 300A, 302B interleaved under a single sensor 301 as shown in FIG. 3. As illustrated in this and the several figures following the signal waveforms are represented as those from zero speed proximity type sensors such as Hall effect devices. But, with suitable signal conditioning variable reluctance sensors may also be used, since as will be disclosed the method requires only a single edge from each tooth or target device.

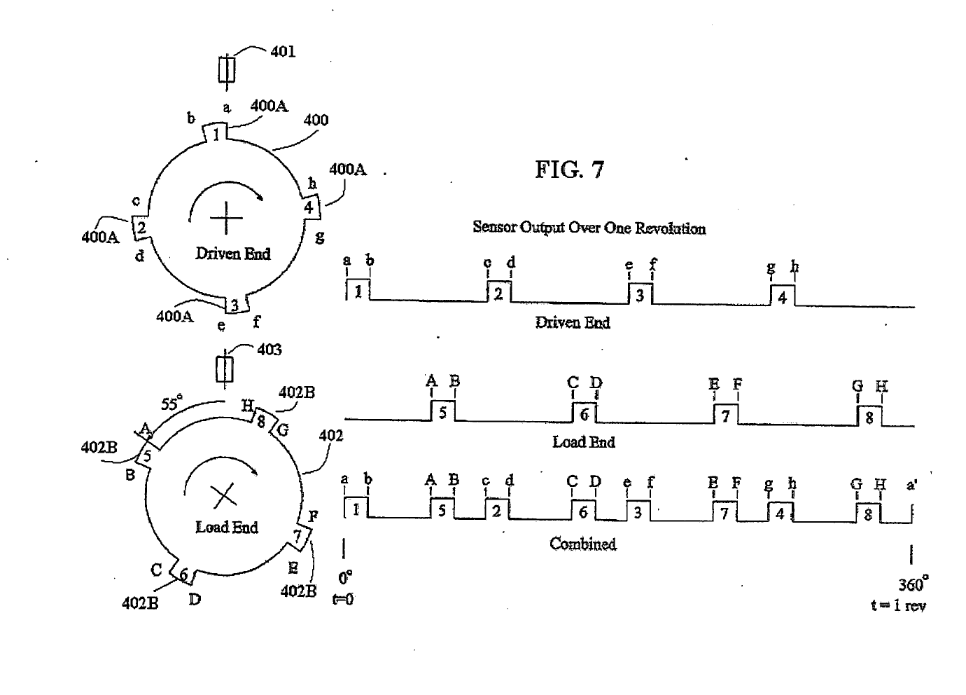

FIG. 7 illustrates an arrangement similar to FIG. 6 but shows the angular relationship and sensor output as it would appear with a torque sufficient to cause 10 degrees of twist being transmitted by the shaft 404. For the purpose of illustration, the disc 400 nearest to the driven end of the shaft 404 has been illustrated in its original position and the disc 402 nearest to the load end of the shaft 404 has been rotated by 10 degrees in a direction consistent with the twist that would occur from drive torque in the direction of rotation indicated for the shaft 404. The digital output signals have also been altered to reflect the changes that would occur in them, and each rising and falling edge has been given a unique identifier. A comparison of FIGS. 6 and 7 shows that the patterns altered in the signals from the sensors 401, 402 when the shaft 404 shown in FIG. 4 takes on twist due to the transmission of torque.

The processing and calculation method according to an embodiment of the present invention is described below. In this discussion the word ‘gap’ will refer to the distance in time between the falling edge of a tooth or target device and the next rising edge of a tooth or target device as seen in the combined sensor outputs. In the combined signals from an interleaved pattern such as those produced by the toothed discs 400, 402 in FIG. 7, the effect caused by the twist produced by torque transmitted in the shaft 404 shown in FIG. 4 will change the difference in size between succeeding gaps by an amount equal to twice the twist produced by the transmitted torque. That is, if torque causes the shaft 404 shown in FIG. 4 to twist by an amount that changes the relative position of the discs by one degree, one gap will be reduced in size by one degree and the succeeding gap will be enlarged by one degree. If the difference in size between the two gaps is computed, it will change by two degrees, or twice the twist produced by the torque. Each succeeding pair of gaps will display the same effect. Thus, one may simply compute half the difference between each succeeding pair of gaps and average these to calculate the twist angle of the shaft 404.

According to an aspect of the present invention disclosed in FIG. 7, a torque measurement method may be implemented by taking into consideration of the fact that not only do successive gaps between the interleaved teeth 400A, 402B manifest a difference in time proportional to twice the twist taken on by the shaft 404, but just the rising edges of consecutive teeth as seen in the interleaved signals do so as well.

Each edge of the teeth illustrated in FIG. 7 has been labeled with a unique identifier. For example, the letters a-h (lower case) for the disc 400 located nearer to the driven end of shaft 404 and A-H (upper case) for the disc 402 located nearer to the load end represent the times at which that edge occurs as measured in ticks of the continuously counting digital clock 40 shown in FIG. 1. Thus, the indication of subtraction of two edge's clock times will yield an actual time elapsed, in clock ticks, between the passages of the referenced edges by their respective sensors 401, 403.

For instance, with reference to the combined signals shown in FIG. 7, (b-a) would be the time elapsed from the passage of the leading edge of tooth 1 of the teeth 400A to the falling edge of tooth 1. The duration in time of the gap in the combined signals immediately following tooth 1 would be represented as (A-b).

With reference to the combined signal, [(A-b)−(c-B)] will be proportional to twice the twist taken on by the shaft 404, since in this case gap (A-b) was increased by 10 degrees of rotation and gap (c-B) decreased by a like amount, with reference to their positions when no torque was present.

Alternatively, the difference it the times between the rising edges of successive teeth may also produce the same numerical result, since the spans defined by these rising edges differ from those of the gaps only by the time of passage of the fixed width of teeth 1 and 5. Thus, [(A-a)−(c-A)] will also represent a time proportional to twice the twist taken on by the shaft 404 as a consequence of transmitting torque.

As discussed above with reference to succeeding gap differences, it may be possible to simply obtain a sum of the four consecutive pairs of successive rising edge to rising edge time differences, divide them by 2, and average them. Indeed, the method according to one embodiment of the present invention is mathematically equivalent to that process, although arranged more in keeping with the requirements of a continuously operating interrupt driven real time process implemented on the digital processor 50 shown in FIG. 1.

In the example described above, each target disc 400 or 402 has four target areas (teeth) 400A or 402B, respectively, but any other number may be used subject only to a practical constraints imposed by the mechanical properties, torques, and dimensions of any particular application. When the two target discs 400, 402 are provided with the same number of teeth or target areas, then when the target discs 400, 402 are interleaved, there will be an even number of consecutive pairs of edges, and the difference between the times of passage of each edge from an edge of the preceding tooth in time will reflect twice the angle of twist in the shaft 404 as compared to that at the zero torque condition. This is particularly convenient because the necessary divisions are by two. Therefore, the calculation process can be carried out in the digital processor 50 shown in FIG. 1 by a simple right shift of one bit on the differenced times as measured in ticks of a binary counting clock, such as the digital clock 40 shown in FIG. 1. Further, when the total number of teeth is chosen to be a power of two (as are the 8 teeth of the example shown in FIG. 7) the final division to obtain the average can also be implemented as a simple right shift of the binary sum, in this case one of 3 bits.

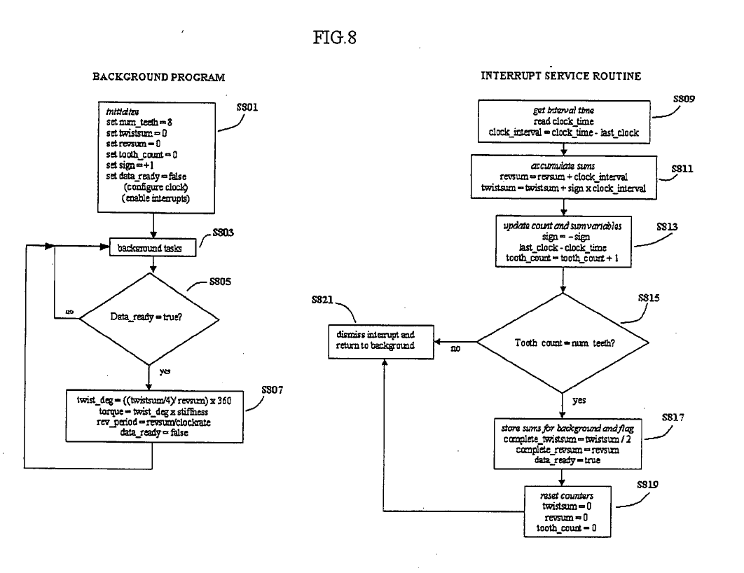

It is convenient to accumulate the required sums as each tooth is detected, since that is when their time of passage must be captured by reference to the digital clock 40, typically by branching to an interrupt service routine disclosed below in regards to FIGS. 8, 9, and 16.

Many commercially available microprocessors include highly integrated semi-autonomous channels for measuring time intervals. For example, the widely used Intel 87C196 family of microcontrollers contain Event Processing Array (EPA) channels, which may be programmed to sample the digital clock 40 shown in FIG. 1 on either the rising or falling edge of a digital input line, and then store the clock reading in a designated buffer and generate an interrupt so that an Interrupt Service Routine (ISR) may be used to process the information. Since the clock reading at each transition is immediately sampled and stored without intervention of the application program, interrupt latency does not affect the results so long as the ISR executes and reads the most recent value before the next interrupt occurs on that channel.

Using the digital processor 50 shown in FIG. 1 for the calculation process for data from the system as disclosed herein may be implemented according to the flowchart and pseudocode of FIG. 8. This process amounts to no more than summing with alternating signs the times, in clock ticks, between the consecutive rising edges of the target signals generated by sensors 401 and 403 shown in FIG. 7 over a period of one revolution. In this example with four target teeth 400A on disc 400 and four target teeth 402B on disc 402, the digital processor 50 accumulates the sum of the four consecutive difference-pairs as they would appear in combined form on a single input channel.

With reference to FIG. 7 where only the rising edges (a, A, c, C, e, E, g, G, a′) are identified, the average of the difference in time between the four consecutive pairs of teeth from alternate discs 400 or 402 is described below. It will be noted that in the figures and text of this disclosure, the symbol a′ indicates the clock time of the second appearance of the leading edge of tooth 1, which edge signals both the start and the end of the single shaft revolution as illustrated herein. The average then is,

{[(A-a)−(c-A)]+[(C-c)−(e-C)]+[(E-e)−(g-E)]+[(G-g)−(a′-G)]}/4

Of course, since each of the four consecutive differences in straight brackets reflects twice the amount of twist of the shaft 404, an additional division by 2 will be required. But, ignoring for the moment the divisions by 4 and by 2 which may be done later, and removing redundant separators, one would obtain,

{+(A-a)−(c-A)+(C-c)−(e-C)+(E-e)−(g-E)+(G-g)−(a′-G)}

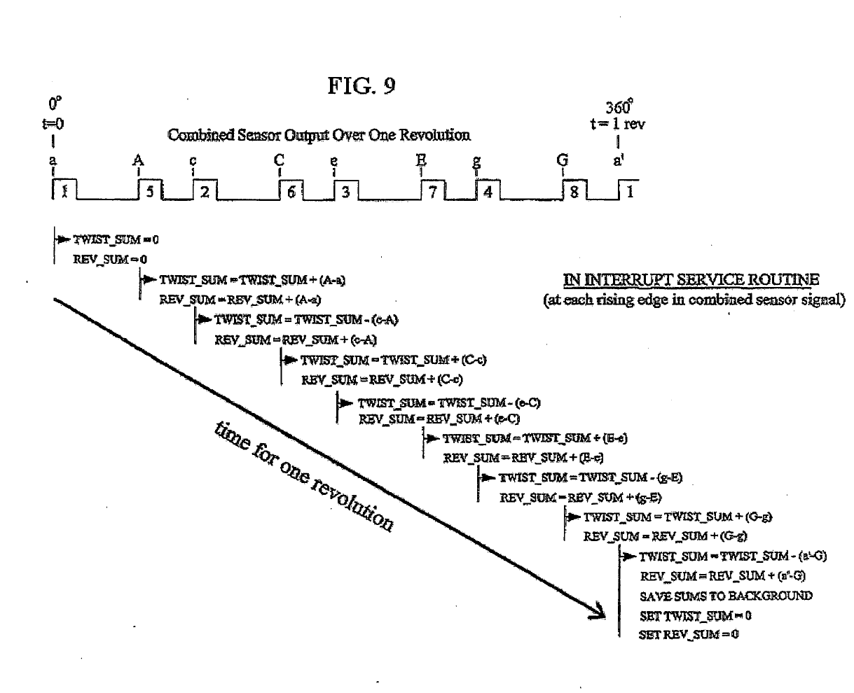

Each of the subtractions within parenthesis simply represents the difference of the digital clock reading when the passage of each tooth is detected from the clock's reading when the previous tooth's passage was detected. An implied sign (+) of the first term is inserted to illustrate that a simple alternating pattern of adding and subtracting the time of passage of each tooth since the previous one will yield the sum required. These simple subtractions are readily done in an ISR servicing the interrupt generated at each edge, and the sum is accumulated by alternately adding and subtracting the consecutive differences. This sum is referred to as twistsum in FIG. 9. An additional accumulation of the edge to edge times all summed will produce the time for one revolution. This sum is referred to as revsum in FIG. 9.

At the end of the revolution of the shaft 404 shown in FIG. 4, the processor 50 shown in FIG. 1 divides the twist sum in clock ticks as produced by the alternating sign accumulation by the total time for one revolution in clock ticks to obtain the fraction of a revolution represented by the twist. In angle, this is the same fraction multiplied by the 360 degrees of one revolution. One may then subtract from it the known zero torque bias inherent in the offset arrangement chosen for the target discs 400, 402 to obtain the actual twist. The twist in degrees over the known section length d of the shaft 404 between the target discs 400, 402 is then readily converted to torque by multiplying that twist angle by the stiffness of the shaft 404.

The time for the complete revolution may then be converted to any convenient units, such as RPM, or for the calculation of horsepower to radians/sec. The product of the shaft speed in radians/sec, the torque expressed in ft-lbs, and the scale factor 550 will yield the horsepower transmitted by the shaft 404.

With reference to FIG. 8, the digital processor 50 shown in FIG. 1 further carries out processes according to a background program and an ISR. At step S801 of the background program the following parameters are initialized: set num_teeth=8; set twistsum=0; set revsum=0; set tooth_count=0; set sign=+1; set data_ready=false.

Step S803 represents any other background tasks that may be performed based on any other needs of the particular application; or it may just be an idle loop if there are no such needs At S805 a decision is being made whether the data acquisition condition is satisfied, which is that one complete revolution of the shaft has occurred. When one complete revolution of the shaft 404 has occurred, step S807 calculates twist_deg, torque, rev_period by the following relationships: twist_deg=((twistsum/4)/revsum)×360; torque=twist_deg×stiffness of the shaft 404; rev_period=revsum/clockrate. If S807 finds that the data is not yet ready [data_ready=false], the background program returns to step S803.

Concurrently, an ISR as shown in FIG. 8 operates to maintain the parameters initialized in step 801 in the background program. The ISR begins with step S809 to obtain an interval time, in which the digital clock 40 shown in FIG. 1 is used to obtain the clock_time of each tooth based on the rising edge of the signal corresponding to the tooth. A clock_interval time is the difference between the clock_time and last_clock time of the previous rising edge signal. At step S811, the ISR accumulates the clock_interval from step S809 to determine one revolution time, revsum, of the rotating shaft 404. Step S811 also accumulates the twist_sum. A time line to determine the clock_interval, revsum, and twist_sum is shown in detail in FIG. 9.

FIG. 9 illustrates the timeline for the ISR as shown in FIG. 8. The timeline start at t=0 which is represented by the first tooth 1 and the rising signal level a at which twist_sum and rev_sum is initialized as zero. At tooth 5, twist_sum and rev_sum is calculated based on the following relationship: Twist_sum=twist_sum+(A-a) and Rev_sum=Rev_sum+(A-a).

Subsequently, the twist_sum and rev_sum are calculated for intervals between (c-A), (C-c), (e-C), (E-e), (g-E), (G-g), and (a′-G) where a′ denotes the clock_time of the second appearance of the rising edge of Tooth 1, i.e., end of the first revolution.

Now reference back to FIG. 8, at step S813 the ISR updates count and sum variables of sign, last_clock and tooth_count. It should noted that the sign variable is always either +1 or −1, alternated with each edge processed by S813, in order to implement the alternating addition and subtraction process herein disclosed. At step S815, the ISR determines whether the tooth_count updated in step S813 satisfies the num_teeth initialized at step S801 of the background program, which is the number of teeth whose passage will constitute one complete revolution of the shaft. If the tooth_count is not equal to the initialized num_teeth, then the ISR ends, and the processor returns to its background tasks or wait loop until the next interrupt occurs. If the tooth_count is equal to num_teeth, the ISR stores sums for background at step S817 where complete_twistsum is equal to twistsum/2 and complete_revsum is equal to revsum. Further, step S817 of ISR records [data_ready=true] indicating that one complete revolution of shaft 404 has occurred. Having stored the accumulated sums at locations available to the background routine, at step S819, the ISR resets twistsum, revsum, and tooth_count to zero to initialize the sums for the next rotation of the shaft. At step S821, the ISR dismisses and returns to background program.

According to an embodiment of the present invention, the process of accumulating a twist estimated by subtraction of the time of passage of only successive rising (or only successive falling) edges inherently subtracts out error sources common to all teeth 400A, 402B over the course of one revolution of the shaft 404 shown in FIG. 4. For instance, the rise time characteristics of the target sensor outputs may vary with shaft speed, or with temperature. So long as that variation is common to all the teeth over the course of one shaft revolution, then the accumulation of the twist estimate as the sum of subtracted tooth passage times will not allow any such systematic errors to affect the results.

The minimum number of teeth or target areas required on each target disc 400, 402 is one, and in that case there will be just one pair of successive edges whose difference in time reflects twice the twist created in the shaft 404 due to torque. But, generating more consecutive pairs of teeth by virtue of employing a greater number of target devices on each disc will have the advantage of benefiting from the averaging effect inherent in the calculation process disclosed herein which will reduce the degree to which noise and higher frequency torsional vibrations degrade the torque estimation.

Regardless of the number of teeth or target elements on the discs 400, 402 one other advantage of computing the twist estimate based on an entire revolution of the shaft 404 is that the total time for each revolution of the shaft 404 will be measured from the edge of one target device back to that same edge after one compete revolution. Thus, no errors or offsets in the placement of that tooth can enter the calculation of the time elapsed for one revolution.

Another aspect of the present invention is that if only the rising, or only the falling edges of the sensor output is used in the calculation then the width of the teeth 400A, 402B does not affect the calculation processes, providing that the width of teeth 400A on disc 400 is not too wide to cause overlap with teeth 402B on the opposite disc 402 when maximum torque is applied to the shaft 404.

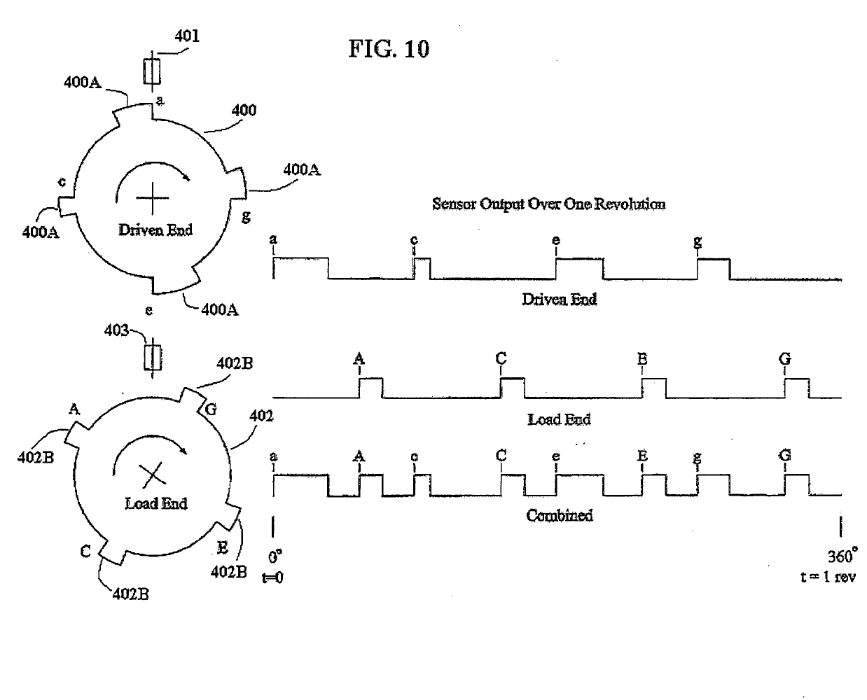

FIG. 10 shows an arrangement similar to that of FIG. 7, but in which the teeth of one of the discs have been altered in their width by arbitrary amounts, for any desired purpose. Note that the teeth 400A, as shown in FIG. 10, have different widths. According to an aspect of the present invention disclosed in FIG. 10, the discs 400, 402 will produce exactly the same twist and torque measures as those of FIG. 7. This offers a simpler alternative for defining a reference or index position than a missing tooth as suggested by conventional teachings.

Consideration should be given to various situations that may occur in a given design with regard to the importance of correctly handing both positive and negative torques, and rotation of the shaft 404 in either direction. The followings are several possible scenarios regarding these considerations depending on the purpose and use of the machinery involved.

In the first instance, there will be machinery which only generates drive torque in one direction, and has no provision for driving the shaft in the opposite direction. Within this category, there are two further possibilities. They involve the situation in which a negative torque may yet be generated in the shaft when the unidirectional drive power is removed without declutching from the load, by virtue of either the rotational inertia of the load being greater than that of the drive mechanism and/or the inherent braking in the drive mechanism being greater than that of the load. This will result in the shaft carrying a torque in the opposite direction to its rotation.

The first category will include those applications in which the shaft 404 is always driven in the same direction and any negative torques that may be generated at shutdown are of no interest and may be ignored. This category may also contain some machinery which does sometimes operate with reverse drive but only rarely and with small torques of little or no interest, such as an automobile or truck driveline.

The second category includes those applications in which it is required to monitor negative torques as well positive ones, with respect to the direction of rotation of the shaft 404. These will include machinery which while always turning the shaft 404 in the same direction does nonetheless require that negative torques, which occur during shutdown or slowdown be monitored. It will also contain machinery which does routinely power the shaft 404 in both directions of rotation, and hence also requires that the torque system measures and correctly reports the sign of the torque in both cases.

One consequence of an arrangement such as shown in FIG. 6 that produces interleaved teeth with symmetrical gaps at zero torque is that the sign of the torque calculated by the method disclosed will depend upon two things. First, it will depend on the direction of the torque being transmitted in the shaft 404. But, it will also depend on which tooth the calculation algorithm begins with. That is, whether the first tooth recognized and used in the calculation happens to be one in which the gap following it increases with torque applied in a given direction, or whether the first tooth processed by the algorithm is one in which the gap following it decreases with torque applied in that direction.

In the case of machinery in the first category defined above, having unidirectional drive and no requirement to monitor negative torque values that may be generated during slowdown, an arrangement such as that illustrated in FIG. 6 may be used by simply taking the absolute value of the torque calculation reported by the processor 50 shown in FIG. 1.

In regard to the second category defined above, where it is required to correctly calculate and sign torques applied to the shaft 404 in either direction, if the implementation contains at least one target disc specifically designed for the purpose of the torque measurement system then it may have a single tooth of different width than the others, which may be used as an index in a startup or initialization algorithm to assure that the sign of the torque calculation occurs in the desired sense. This may be detected by sharing the signal from that disc with another input channel whose interrupt is configured to occur at both rising and falling edges, with only the rising edge used in the torque calculation. This would require that separate channels were used for processing the outputs of the two sensor channels.

If it was desired to still use a single processor channel operating on two sensor inputs combined into a single signal it is a further teaching of this invention that this may be effected by offsetting the relative angular positions of the discs 400, 402 at zero torque so that the output of the calculation is not zero, but reflects a known and constant initial bias. If the absolute value of the calculation result is then taken it will be seen that in fact torque acting on the shaft 404 in one direction will cause the absolute value of the twist estimate produced by the calculation to increase, and torque acting in the opposite direction will cause the twist estimate produced by the calculation to decrease. Thus, subtracting the known fixed twist bias at zero torque from the twist number produced by the calculation will produce a correctly signed torque value.

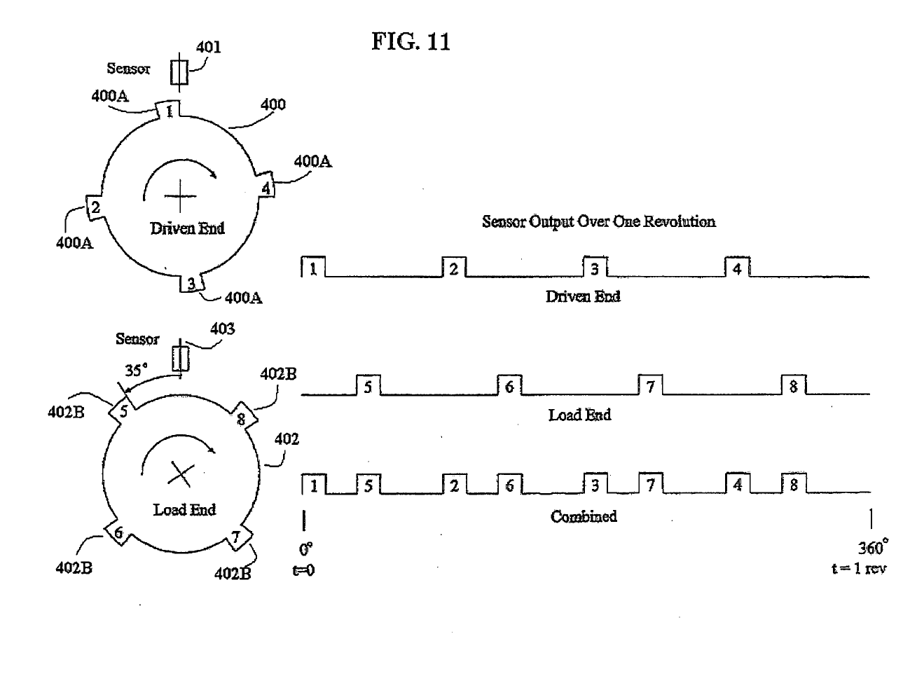

FIG. 11 illustrates an arrangement similar to FIG. 6, except that a static alignment of the toothed discs at zero torque has been intentionally offset to an asymmetrical state in according to an embodiment of the present invention. Instead of the second disc 402 being rotated by 45 degrees from the first disc 400 in its zero torque state it has been rotated 35 degrees. Thus, when the shaft 404 is rotating with zero torque the calculation will produce a twist sum equivalent to either +20 degrees (if the process has begun with the tooth marked 1 or 3, since 55−35=20) or −20 degrees (if the process has begun with the tooth marked 2 or 4, since 35−55=−20). In either case, if the twist sum is divided in half and its absolute value has the known offset of 10 degrees subtracted from it, the result for zero torque will be correct.

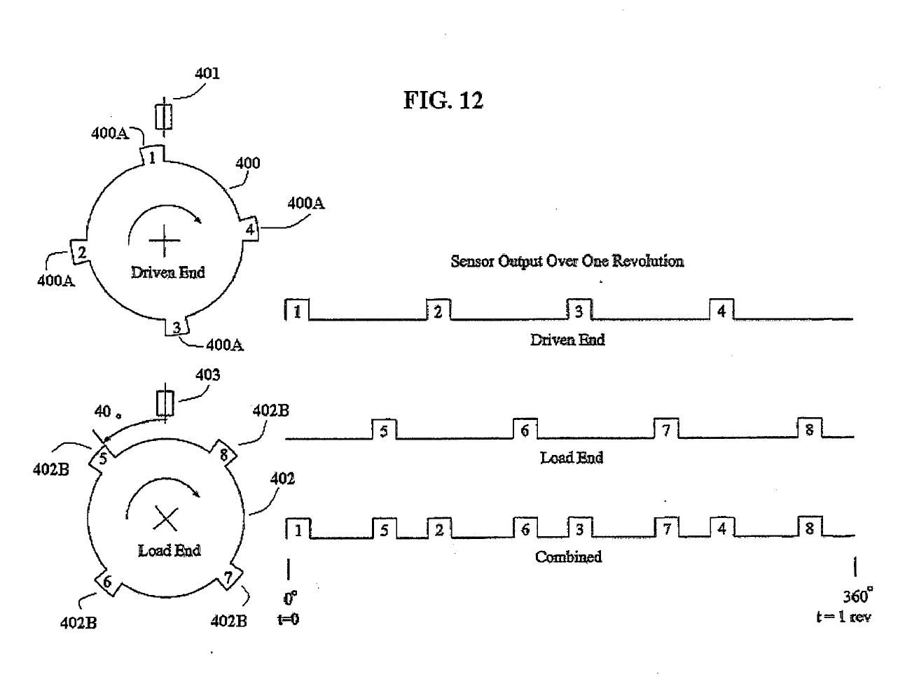

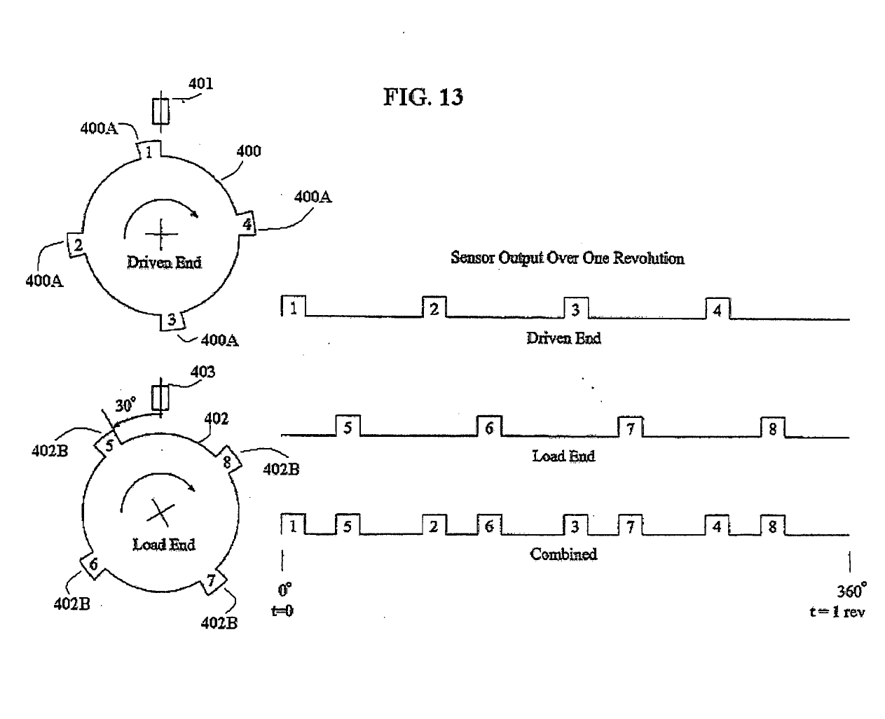

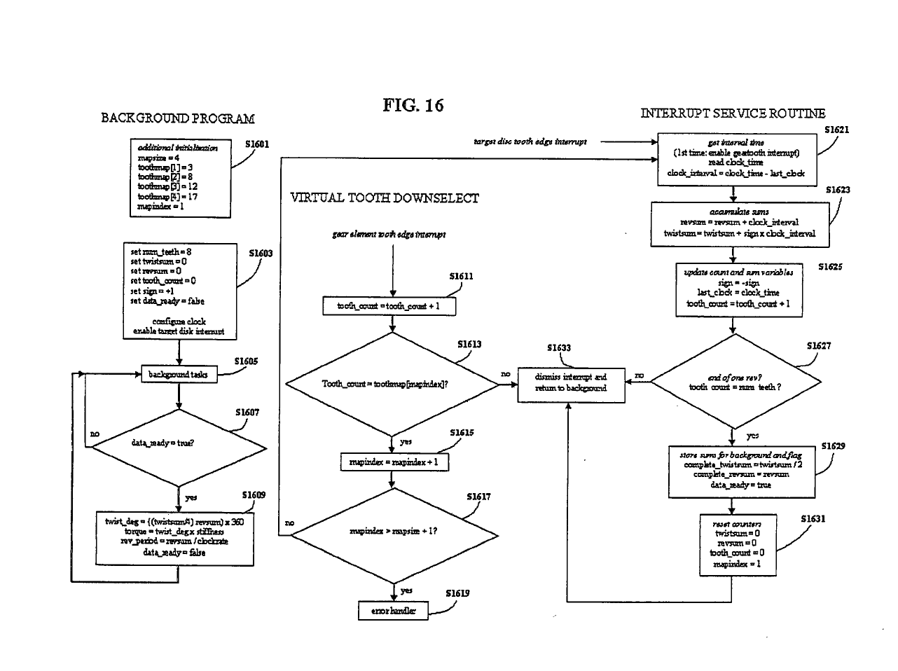

However, it will be seen that if, as in FIG. 12, torque produces 5 degrees of twist in the shaft 404 in the direction of shaft rotation, then the absolute value of the calculation will produce the number 15, regardless of which tooth the process has begun with. Equally, as illustrated in FIG. 13, if torque in the opposite direction to rotation of the shaft 404 produces 5 degrees of twist the result of the calculation will be 5, regardless of which tooth the process has begun with. If the known constant offset of 10 degrees is subtracted from the result in each of these cases it will produce the correctly signed numbers of +5 and −5 degrees respectively. Although not shown for clarity on FIG. 8 and FIG. 16, in all cases the final step in calculating the twist is to subtract the known angular offset at zero torque from the offset calculated by the method disclosed here. The only exception would be if zero offset at zero torque was chosen as appropriate for the particular application.

However, the actual offset chosen from the symmetrical position may be chosen with consideration of the maximum torques produced in each direction to rotation of the shaft 404 in a particular application. For example, if the maximum torque in each direction is not equal, the offset may be chosen so as to allow larger amounts of twist in the direction in which the machinery produces larger torques.

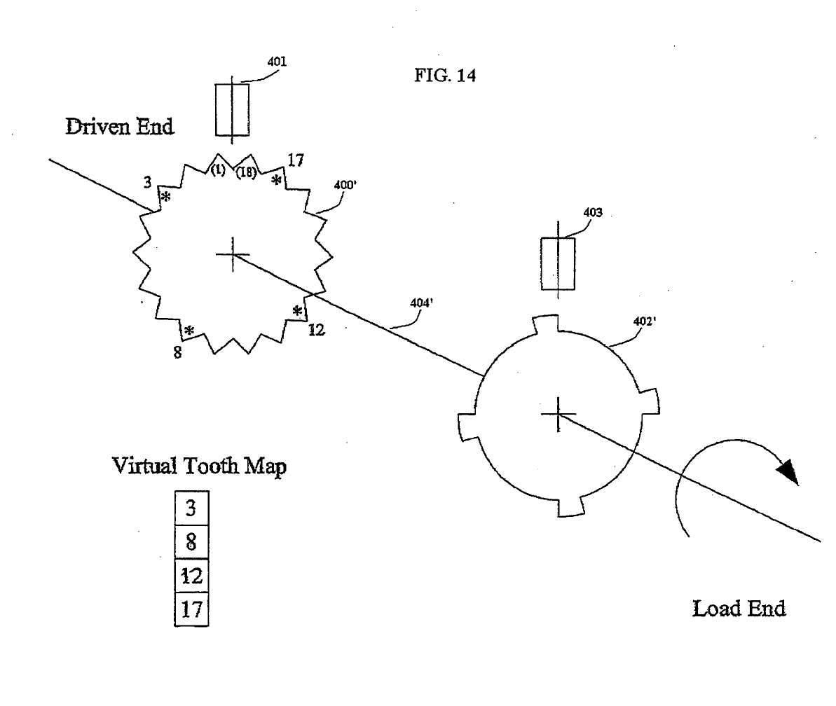

FIG. 14 illustrates how an existing gear inherent in machinery may also be used as a target disc element in a torque measurement system implemented according to an embodiment of the present invention. In this embodiment, one or both of the pair of target discs/gears 400′, 402′ may be discs with many more teeth than required for the purposes of the torque calculation method disclosed above, which numbers can be reduced in software by ignoring unwanted teeth in a pattern chosen to result in a suitable number of appropriately spaced ‘virtual’ teeth 3, 8, 12, 17, and only these teeth are used in the calculation algorithm performed by the processor 50 shown in FIG. 1.

In particular, discs/gears 400′, 402′ may be functional, stressed gears already present in the mechanism as required by its inherent function and design. Discs/gears 400′, 402′ need not be paired with another disc of equal numbers of teeth, but rather their number of teeth can be reduced for the purposes of calculating the twist of the shaft 404 shown in FIG. 4 in a manner consistent with the teachings of the present invention by having the digital processor 50 ignore the edge signals from selected teeth, in a pattern chosen so that the remaining teeth whose times of passage are used in the torque measurement calculation produce an interleaved, offset pattern similar to those previously discussed with reference to discs designed and installed solely for the purpose of generating timing signals for torque measurement.

If only one of the target discs is an existing gear then the second target disc added to such device so as to complement the tooth pattern of the selected teeth on the existing gear, and may contain an index mark, for instance a wider or narrower tooth, which will facilitate initialization of the tooth selection map. Alternatively, it may also be the case that a second pre-existing gear element in the machinery may be used in a similar way with an appropriate pattern of teeth down-selected from the full complement present on the gear. In this case, initialization may require a scheme suited to the particular details of the gear elements and the operating scenario of the machinery.

According to an exemplary embodiment, teeth from a gear together with a purpose made second target disc is illustrated in FIG. 14, which shows a gear 400′ with 18 teeth, fixed to a shaft 404′ as an inherent part of the machinery and nearer to the driven end, while its partner disc 402 in the torque calculation is designed for that specific purpose and attached nearer to the load end of shaft 404′. In this case, an operating software would look for the first rising edge on the secondary (purpose-made) disc wheel and from that point on would employ a tooth map similar to the one illustrated to down-select from the 18 teeth in the gear element those 4 that result in the best arrangement of interleaved edges according to the teachings of the invention. In the example, these virtual teeth 3, 8, 12, 17 have been marked with asterisks (*).

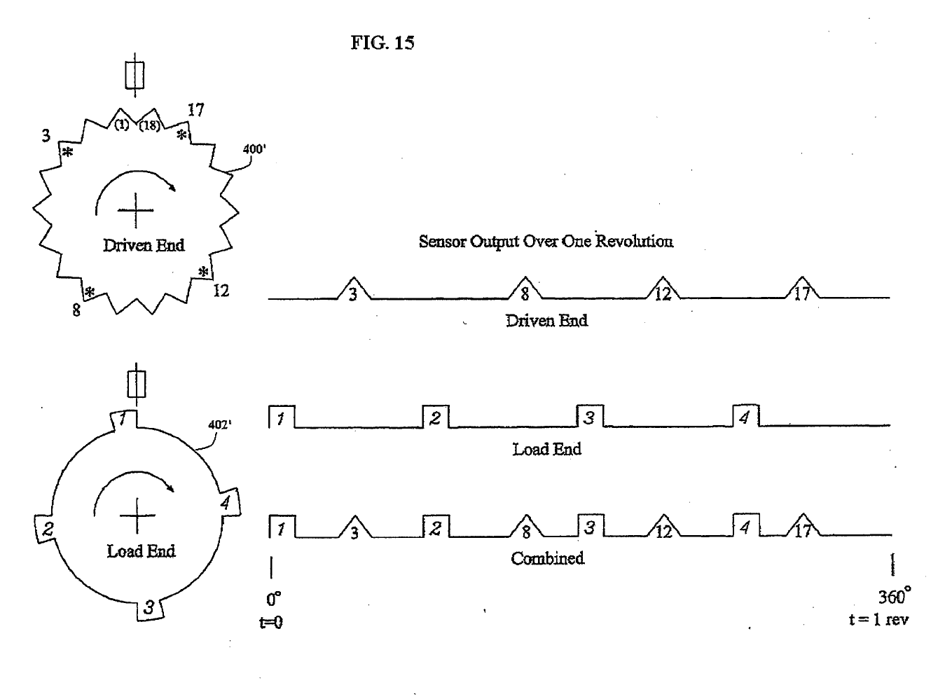

FIG. 15 illustrates a gear element tooth disc shown in FIG. 14 and its companion disc in same axial and temporal views. For the purposes of this illustration, the signals from the gear teeth 400′ used are illustrated as triangular, both to differentiate them from the teeth of the other disc and to indicate where their actual timing point would be if the output of a variable reluctance sensor used to detect them was signal conditioned with a zero-crossing detector (not shown).

FIG. 16 illustrates an alternate embodiment wherein the background program of FIG. 8 initializes additional parameters. FIG. 16 illustrates such an initialization process in the form of a flowchart and pseudocode in which the scheme consists in applying the tooth map chosen in FIG. 14, whose entries reflect the sequence number of the teeth or other target devices to be used in the calculation in a repetitive manner starting at some known point in relation to the other disc. In the case of the first example shown, one of the disc elements is an existing gear and the other is a target disc designed and installed solely for the purpose of completing the pair in such a way as to facilitate the torque calculation according to the teachings of this invention. For the purposes of illustration, the purpose made disc includes four teeth at intervals of substantially 90 degrees.

As mentioned earlier, FIG. 16 illustrates an alternate embodiment wherein the background program of FIG. 8 initializes additional parameters. For example, At step S1601, the background program initializes the following additional parameters: mapsize=4; toothmap[1]=3; toothmap[2]=8; toothmap[3]=12; toothmap[4]=17; and mapindex=1. At S1607 a decision is being made whether the data acquisition condition is satisfied, which will have been indicated by the ISR when one complete revolution of the shaft has occurred. At step S1603 of the background program, the following parameters are also initialized: set num_teeth=8; set twistsum=0; set revsum=0; set tooth_count=0; set sign=+1; set data_ready=false. Step S1605 is a waiting condition, it may be an idle loop or it may allow the processor to carry out any other background tasks useful in the particular application. At step S1607 the background program starts the calculation algorithm once one complete revolution of the shaft had occurred. Step S1609 calculates twist_deg, torque, rev_period by the following relationships: twist_deg=((twistsum/4)/revsum)×360; torque=twist_deg×stiffness of the shaft 404; rev_period=revsum/clockrate. Having finished the calculations for the most recent revolution S1609 then sets data_ready=false and the background program returns to step S1605.

The additional parameters are used to run a virtual tooth down-select program illustrated in FIG. 16. The virtual tooth down-select program starts with tooth_count step S1611. The tooth_count determined at step S1611 is compared to toothmap[mapindex] at step S1613. If the tooth_count is not equal to toothmap[mapindex] then the virtual tooth down-select program dismisses interrupt and returns to background program. If the tooth_count is equal to toothmap[mapindex] then the virtual tooth down-select program reiteratively counts the mapindex by increment of 1 at step S1615. Further, the virtual tooth down-select program compares mapindex to mapsize increment by 1 at step S1617. If mapindex is greater than mapsize +1, the virtual tooth down-select program passes to error handler at step S1619. If mapindex is not greater than mapsize +1, the virtual tooth down-select program passes to ISR program disclosed below.

The ISR begins with step S1621 to obtain an interval time, in which the digital clock 40 shown in FIG. 1 is used to obtain the clock_time of each tooth based on the change of state of the signal corresponding to the passage of the tooth. A clock_interval time is the difference between the clock_time and last_clock time of the previous rising edge signal. At step S1623, the ISR accumulates the clock_interval from step S1621 so that at the end of one complete revolution it will represent the total time of that revolution, revsum, of the rotating shaft 404′. Step S1621 also determines the twist_sum. A time line to determine the clock_interval, revsum, and twist_sum is shown in detail in FIG. 9 as disclosed above with reference to FIG. 8. At step S1625, the ISR updates count and sum variables of sign, last_clock and tooth_count. As step S1627, the ISR determines whether the tooth_count updated in step S1625 satisfies the num_teeth initialized at step S1603 of the background program, which will mean that one complete revolution of the shaft has occurred. If the tooth_count is not equal to the initialized num_teeth, then one complete revolution has not taken place and Step 1627 proceeds to Step 1633 and the processor returns to the background program. If the tooth_count is equal to num_teeth, the ISR stores sums for background at step S1629 where complete_twistsum is equal to twistsum/2 and complete_revsum is equal to revsum. Further, step S1629 of ISR records [data_ready=true] indicating that the sums for one complete revolution of the shaft are now available to the background program. At step S1631 the ISR resets twistsum, revsum, and tooth_count to zero and mapindex to 1 in preparation for accumulating the sums for the next revolution. At step S1633, the ISR dismisses and returns to background program.

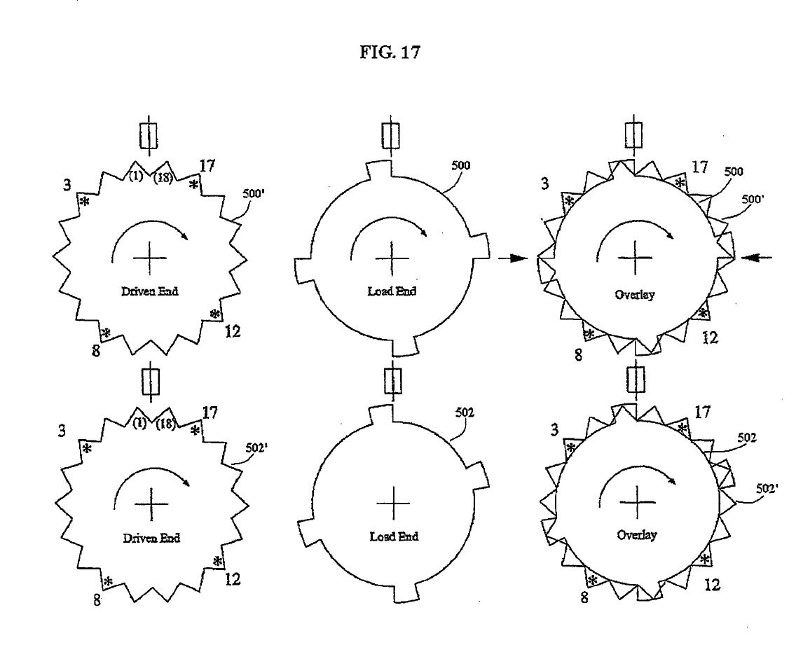

FIG. 17 shows two possible arrangements of the second, purpose-made disc, 500 or 502 and how they would relate to the gear element target disc 500′ or 502′ when overlaid in axial view. The first purpose made disc 500 in the top row of FIG. 17 is similar to those shown in previous figures, with four equal width teeth at 90 degree intervals. Its relationship to the gear element teeth of the target disc 500′ at zero torque is determined by the circumferential position at which it is fixed on the shaft 404′ shown in FIG. 14. Its relationship to the gear element teeth of the target disc 500′, shown in overlay, is only one possible arrangement.

However, the arrangement shown in the bottom row of FIG. 17 provides a better arrangement, since a slight displacement of two of the teeth results in each of the teeth on the purpose-made disc 502 occurring exactly midway between two teeth on the gear element disc 502′. Thus, at first motion, the initialization process may look for a rising edge on the purpose-made disc 502, and cause the tooth map down-selection process to begin on the next rising edge generated on the gear element target disc 502′.

Although, that first edge seen from the purpose-made disc 500, 502 may be any of the four there is no reason to prefer any one over another since the results will be the same. It is also the case that in this configuration a correct initialization will ensue so long as the torque present during the initialization process is not sufficient to twist the shaft 404′ shown in FIG. 14 by more than the angle represented by half the spacing between the teeth on the gear element target disc 500′, 502′. Indeed, if it is known that torque present at initial motion always occurs in one known direction then a further offset could be effected so that all four leading edges of the second target disc's (500′ or 502′) teeth occurred just after a falling edge of a gear element tooth, thus allowing a torque sufficient to twist the shaft 404′ through an angle of nearly one whole gear element tooth width with no effect on the initialization process.

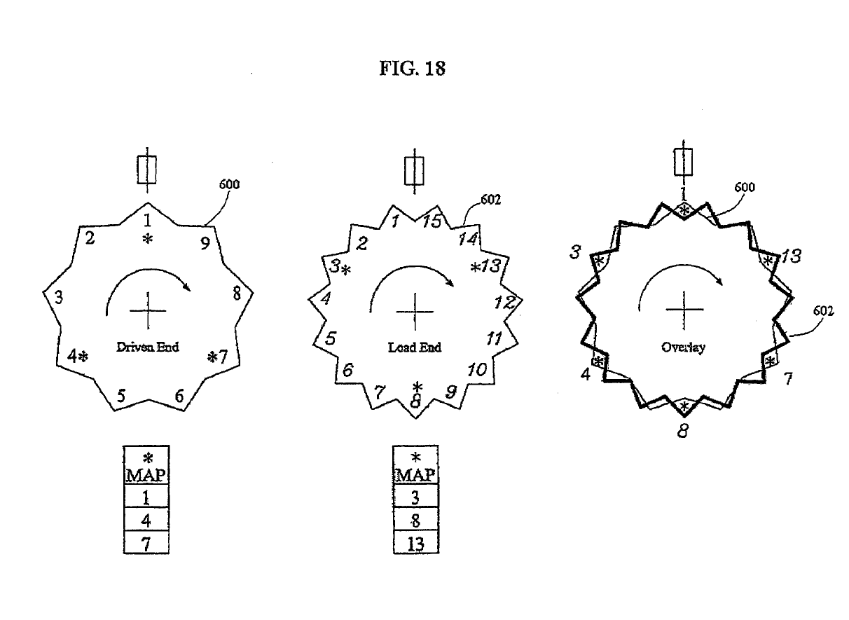

FIG. 18 shows another example of down-selection of virtual teeth, wherein both discs are implemented from existing gear elements. In FIG. 18, two existing gear elements are used to constitute target discs 600, 602 for a system in according to an embodiment of the present invention. The target disc 600 includes 9 teeth and the target disc 602 includes 15 teeth. In an exemplary embodiment, three teeth have been selected from each target discs so as to be spaced at intervals of 120 degrees, since each of the gears contain a number of teeth (9 and 15) evenly divisible by 3. Virtual teeth 1, 4, and 7 have selected for target disc 600 and virtual teeth 3, 8, and 13 have been selected for target disc 602.

Thus, the above arrangement produces a tooth pattern with symmetrical gaps at zero torque. If, due to considerations of sign ambiguity this is not acceptable, then other teeth may be selected which will produce the desired asymmetric gaps at zero torque according to embodiments of the present invention discloses earlier.

Alternatively, in a situation where an extant gears may not be divisible by a practical common factor, an aspect of the present invention provides that the gaps created by the virtual teeth, or by real ones, need not all be of the same size, so long as they continue to satisfy the condition that at the maximum torque that will be transmitted in the shaft 404′ shown in FIG. 14, no overlap of the edges occurs. Gaps of different sizes will result in a changed offset or bias in the twist calculation, but it will nevertheless be the case that the change in the difference between the times of passage for any two successive teeth will still be twice the twist produced by the torque carried in the shaft 404′.

The specific constitution of a particular tooth maps for any such arrangements may be determined by the details of the number and spacing of the teeth on pre-existing gear elements, and by the usual constraints associated with the limiting twist which will be produced by the maximum torque that the shaft 404′ will carry. It may be more difficult in some applications than in others to find an optimal arrangement, but in any case, it may always be possible to find some solution since in the limiting case each gear can have just one virtual tooth selected for use, which provides a single difference pair in each revolution.

Further, according to another embodiment of the present invention, a higher update rate for torque estimation may be obtained from the calculation process disclosed herein by means of employing a re-circulating ring buffer in which the individual tooth or target times of passage are stored, together with a calculation which at each tooth passage updates the running sums to be consistent with the data from the last complete revolution of the shaft leading up to the tooth or target just seen. In this way a torque estimation may be output after each tooth or target passage, each estimate reflecting the torque as calculated over the preceding complete revolution.

A ring buffer is a software construct which uses a set of consecutive memory locations as though they were arranged in a ring or circle instead of sequentially. It is particularly useful in applications where there is a continuous stream of data elements that must be stored, but only for a limited amount of time. Software maintains a pointer to the current location in the buffer, which is incremented at each use. When the pointer reaches the end of the buffer it is reset to the initial position. Thus as the data items become available the application software fills the buffer from its beginning point. When it is filled to its defined length, the software program stores the next data item back in the initial location and continues onward as before.

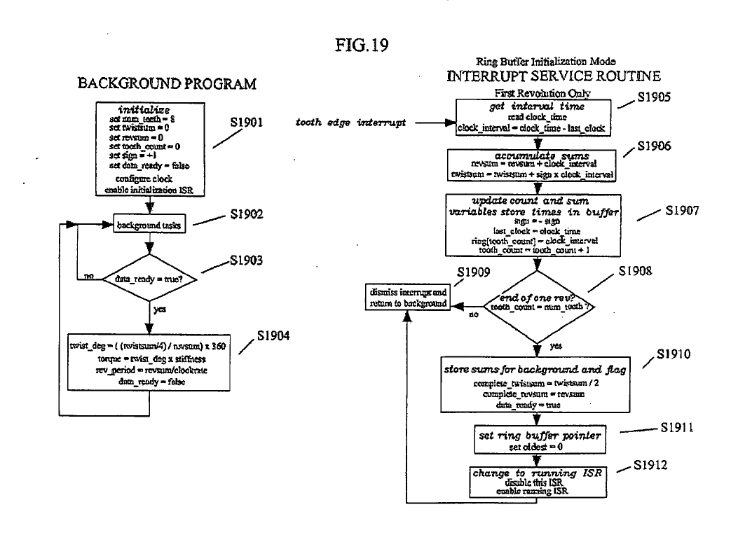

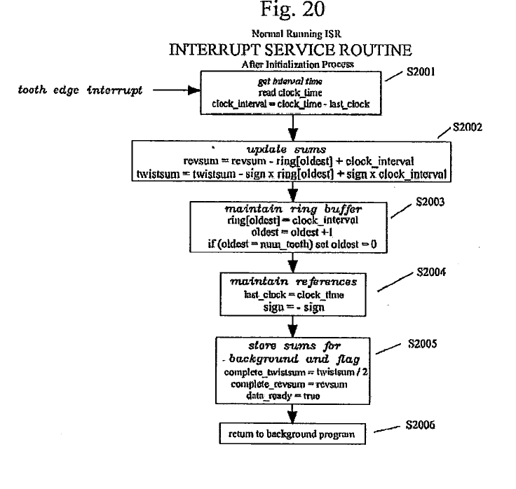

In the case of the invention here disclosed, whatever the arrangement of teeth or target devices chosen for the two locations on the shaft, there will be a fixed number of them that are detected in the course of one complete revolution. In the context of the computational algorithm here disclosed, the ring buffer will be equal in size to the number of tooth or target edges that pass by the sensors and are accepted as targets in one complete revolution of the shaft. For the first revolution of the shaft each elapsed time since the previous edge in clock counts is stored in consecutive locations in the ring buffer as well as being used to accumulate the sums as before. At the end of that complete revolution the accumulated sums are made available to the background routine as before. However, from this point on a different processing algorithm takes place, as illustrated in FIGS. 19 and 20.

FIG. 19 shows in form similar to FIG. 8 how the first revolution of the shaft in such an implementation would be implemented. In this case, the background program initializations at step S1901 now include a specific enablement of the ‘initialization ISR’, which will be the interrupt service routine shown on the right, which is used only to initiate the process over the course of the first revolution of the shaft. This routine is very similar to that of FIG. 8, but it has several added steps. Steps S1902, S1903, S1904, S1905, and S1906 are identical to steps S803, S805, S807, S809, and S811 respectively. In step S1907 it stores each clock_interval difference in an element of the buffer ring. The counter tooth_count has been used as the location pointer within the buffer ring. This counter was included previously simply to count passage of the teeth or target devices so as to determine the end of one complete revolution. Note that it is used as a location pointer for ring before it is incremented, as the locations within the ring buffer will be addressed as 0 to 7, while the original use of tooth_count is as a counter incrementing from 1 to 8.

The functioning of this initialization ISR is otherwise identical to the one of FIG. 8 until one complete revolution has taken place. In this case, when at step S1908 tooth_count is found to equal num_teeth it completes calculations as before and sets the flag data_ready=true for the background routine at step S1910. However, at step S1911 it then initializes a pointer for the ring buffer (oldest) and also at step S1912 changes the vector associated with the interrupt to point to a different ISR, the one that will be used now that the ring buffer has been initialized. This ring buffer ISR is illustrated in FIG. 20. At step S1909, the ISR dismisses and returns to background program.

FIG. 20 illustrates in similar form the working of the Interrupt Service Routine after the initialization process has completed. The background program remains unchanged and is not repeated in this figure.

As each tooth or target edge generates an interrupt this ISR computes at step S2001 the time elapsed in clock ticks since the previous edge, just as was done in the previous implementation. However, in this case it then only needs to update the sums from the last complete revolution, revsum and twistsum. At step S2002 for each of these sums it adds the most recent time interval (clock_interval) and subtracts the clock time from the corresponding interval on the previous revolution, which is found in the oldest time location in the buffer. It then at step S2003 maintains the buffer by replacing the oldest time with the newest, and incrementing the buffer pointer. If the incremented buffer pointer indicates that the end of the buffer has been reached it is reset to the first location in the buffer, so that the process may continue in indefinitely. It then continues in the following steps to maintain the reference time (S2004), store the sums for the background routine and set the data_ready flag (S2005) and returns to the background program (S2006) as in the previous implementation.

The preceding explanation of using a ring buffer to calculate a torque estimate at the edge of every tooth or target device is valid whether the edges chosen are just the rising edges or just the falling edges. It is a further teaching of this invention that a second, identical interrupt service and calculation routine can be implemented to run just as described above but using only the other edges. That is, if the ring buffer implementation described above used only the rising edges of each tooth or target device, an identical routine set up with interrupts generated at only the falling edges of the teeth or target devices could be running at the same time, so that the two routines together would generate a torque measurement at every rising and at every falling edge. This would double the number of torque estimates made in one revolution of the shaft.

Not only would some applications benefit from a higher rate of independent torque estimates, but some applications where even a much lower torque estimate update rate is sufficient could benefit from such an implementation, by obtaining the maximum possible number of torque estimates during the course of each revolution and averaging or filtering them into an estimate output at the lower rate required. This may be particularly useful in applications where torsional vibrations are present in the shaft at relatively high frequencies.

Many practical examples of applications which may advantageously incorporate an existing element in the machinery as one or both of the target disc elements can be found. As one example, consider a driven wheel on an automobile. In a typical configuration, there will be a differential mechanism at the center of the automobile which receives drive from the engine and turns it through 90 degrees so as to drive axles which run laterally across the automobile to the driven wheels on either side. In this case, there may be a side gear element in the differential which is fixed to the axle shaft at its inner end, often by a spline arrangement.

It is also very common for modern passenger vehicles to be equipped with an antilock braking system. These systems measure the speed of rotation of each of the wheels independently, and reduce the braking force directed to any wheel which appears, by virtue of its speed as compared to the others on the vehicle, to be on the verge of lockup. More advanced systems may also compute the individual wheel accelerations and use that quantity as well in their implementation. An inherent part of such systems is at each wheel a toothed ring and suitable sensor arranged so as to allow the measurement of the speed of the wheel. These are often located outboard of the end of the axle shaft as part of the wheel/hub assembly. This toothed ring and its sensor, already present in the design, can be combined with an additional sensor placed so as to sense the passage of teeth at that axle's drive gear in the differential to form a torque measurement system for that axle, according to the teachings of this invention, which requires only a single additional sensor, sensor processing channel and suitable software.

It may also be that U-joints or constant velocity joints may be employed between a differential side gear and an outboard ABS tooth ring so as to allow for the angular displacement of the driven shaft with wheel (suspension) motion. These universal joint pairs or constant velocity devices may not have the same stiffness as the drive shaft. But, the effective stiffness of the total of stressed members in rotation between the side gear at the differential and the ABS sensor at the wheel can be calculated or measured and used in the calculations of a torque measurement system such as the one disclosed herein. Similar joints or couplings in the shaft between the target discs may occur in other applications, but the effective stiffness of the stressed members in rotation between the target discs may always be determined.

It is yet another teaching of this invention that in addition to actual gears and purpose-made target discs, other entities may exist in common machinery which can supply accurate time of passage information for known circumferential locations at known points on a shaft. For example, a brushless DC electric motor, which does not employ brushes contacting armatures on the shaft in order to shift electrical power appropriately to alternating sets of windings, but rather employ sensors viewing interrupters placed at known intervals around the shaft along with a digital processor programmed to sense and interpret these position indications and electrically switch the power as required to successive windings. In the course of tuning these motors to an efficient state the timing of the system is refined to a high degree of accuracy, and these pre-existing shaft position indicators, already in the form of electrical signals suitable for use in a system such as here disclosed, may readily be used to form one of the target disc/sensor elements of the system.

As yet another example, electronic ignition systems providing the spark to modern internal combustion engines typically synthesize precise spark timing for each cylinder by means of a sensor positioned to record the passage of teeth on a disc at the rear of the crankshaft. Typically, it might have a provision such as a missing tooth to provide indexing to a known reference position on the crankshaft. While the earliest systems had a small number of teeth for timing purposes, often just one tooth relating to each cylinder spark time as determined by the design of the crankshaft throws and firing order, the more recent trend is to have considerably more teeth so that the spark timing may be calculated more precisely, taking into account variations in crank speed within one revolution.

A typical example might be a 52-2 disc, which would have 52 equally spaced teeth but for two having been removed to create an unambiguous index. But, regardless of the actual triggering mechanism used, the program executing in the ignition systems digital processor will have a very precise knowledge of the crankshaft position at all times, and with simple software modifications could synthesize a digital pulse output stream with the rising edges of the pulses in any desired arrangement with respect to the rotating crankshaft, suitable for use as one of the elements in a system such as the one discloses herein.

Moreover, in many cases, it might be desirable for the ignition system digital processor to have the signals from the other disc element interfaced to it and for the ignition system digital processor itself to be the processing element for the torque calculation, since in many cases this would be quite practical given the very low computational burden of a torque measurement system constructed according to the teachings of the present invention.

The system and method of the present invention is appropriate for use with sensor types designed to detect the passage past the sensor of ferrous material, magnetic poles, optical targets, reflective targets, or any other target devices which together with their appropriate sensors produce an electrical signal that indicates the passage of the targets by the sensor.

A system which incorporates other pre-existing features or mechanisms of the machinery in which the shaft operates, that for other purposes already acquire precise information about the shaft's position at known times that can be made available in a form suitable to constitute one or more of the target discs for a torque measurement system constructed according to the teachings of the present invention.

Although the invention is primarily described herein using particular embodiments, it will be appreciated by those skilled in the art that modifications and changes may be made without departing from the scope of the present invention. As such, the method disclosed herein is not limited to what has been particularly shown and described herein, but rather the scope of the present invention is defined only by the appended claims.

1. A system for measuring torque transmitted in a rotating shaft subject to torsional twist using two target devices located at two locations on the shaft, each including one or more reference edges, with two sensors each disposed adjacent to corresponding target device for determining the passage of corresponding reference edge at each location during the rotation of the shaft and generating an electrical signal whose value is altered as the reference edges pass the sensor, comprising:
a counter associated with each said sensor for producing a count value representative of the time between the passing of a said reference edge and a counter reset, said counters being reset in a known relationship;
a processor for calculating a difference between the clock times of successive reference edges to produce an actual time elapsed, with reference to the counter, between the passages of the referenced edges by their respective sensors, wherein a change in time difference represents a time proportional to twice the twist of the shaft as a consequence of transmitted torque, said processor converts the change in time difference into a value that represents a change in the angular orientation of the two target devices with respect to their angular orientation at zero torque, which is substantially equivalent to an angle of twist in the rotating shaft between the target devices, and the processor calculates the torque transmitted in the rotating shaft based on said change in angle of twist.

2. The system according to claim 1, wherein the two target devices are interleaved toothed target rings and the sensor outputs electrical signals to reflect passage times of the teeth of both rings.

3. The system according to claim 2, wherein the processor is a digital microprocessor which determines a sign of the torque being transmitted in the shaft by subtracting a static (zero torque) offset between the two interleaved toothed target rings from an absolute value of a relative offset of the two toothed rings.

4. The system according to claim 1, wherein the two target devices are non-interleaved toothed target rings, each including a sensor to output electrical signals to reflect passage times of the teeth of each ring.

5. The system according to claim 4, wherein the processor mixes the output signals of each sensor in order to process the signals using a single processing channel.

6. The system according to claim 4, wherein the processor determines a sign of the torque being transmitted in the shaft by subtracting a static (zero torque) offset between the two non-interleaved toothed target rings from an absolute value of a relative offset of the two toothed rings.

7. The system as in claim 1, wherein each of said target devices having a plurality of radially or axially disposed target patterns along the periphery of the target devices.

8. The system as in claim 1, wherein the processor is a digital processor calculates a sum of electrical signals with alternate signs over one complete revolution of the shaft.

9. The system as in claim 1, wherein the electrical signal exhibits a transition indicating the passage of a specific circumferential location on the surface of the shaft associated with the target devices.

10. The system as in claim 1, wherein the angle of twist is calculated from either rising edges or falling edges of the target passage signals generated by the sensor.

11. The system as in claim 1, wherein the torque is calculated based on the change in angle of twist, stressed distance between the target devices and the shaft's stiffness.

12. The system as in claim 1, wherein the counter is a digital timing clock.

13. The system according to claim 12, wherein the processor changes the clock rate as a function of shaft speed.

14. The system as in claim 1, wherein the processor calculates a change in a difference between two successive gaps over one complete revolution wherein the gaps represents a distance in time between a rising or falling edge of a target device and another rising or falling edge of the target device.

15. The system as in claim 13, wherein the effect caused by the twist produced by torque transmitted in the shaft will change the difference in size between succeeding gaps by an amount equal to twice the twist produced by the transmitted torque.

16. The system as in claim 1, wherein the processor utilizes a re-circulating ring buffer in which the individual target times of passage are stored, together with a calculation which at each target device passage updates running sums to be consistent with data from the last complete revolution of the shaft leading up to the target device just passed.

17. A method for measuring torque transmitted in a rotating shaft subject to torsional twist using two target devices located at two locations on the shaft, each including one or more reference edges, with two sensors each disposed adjacent to corresponding target device for determining the passage of corresponding reference edge at each location during the rotation of the shaft and generating an electrical signal whose value is altered as the reference edges pass the sensor, characterized in:
producing a count value representative of the time between the passing of a said reference edge and a counter reset, said counters being reset in a known relationship;
calculating a difference between the clock times of successive reference edges to produce an actual time elapsed between the passages of the referenced edges by their respective sensors, wherein a change in time difference represents a time proportional to twice the twist of the shaft as a consequence of transmitted torque,
converting the change in time difference into a value that represents a change in the angular orientation of the two target devices with respect to their angular orientation at zero torque, which is substantially equivalent to an angle of twist in the rotating shaft between the target devices, and
calculating the torque transmitted in the rotating shaft based on said change in angle of twist.

18. The method as in claim 17, further comprising: determining a sign of the torque being transmitted in the shaft by subtracting a static (zero torque) offset between the two target devices from an absolute value of a relative offset of the two target devices.

19. The method as in claim 17, wherein each of said target devices having a plurality of radially or axially disposed target patterns along the periphery of the target devices.

20. The method as in claim 17, further comprising: calculating a sum of electrical signals with alternate signs over one complete revolution of the shaft.

21. The method as in claim 17, wherein the electrical signal exhibits a transition indicating the passage of a specific circumferential location on the surface of the shaft associated with the target devices.

22. The method as in claim 17, further comprising: calculating the angle of twist from either only rising edges or only falling edges of the target passage signal.

23. The method as in claim 17, further comprising: calculating the torque based on the change in angle of twist, stressed distance between the target devices and the shaft's stiffness.

24. The method as in claim 17, further comprising: positioning the target devices so that there is a differing in position of their respective reference edges.

25. The method as in claim 17, further comprising: calculating a change in a difference between two successive gaps over one complete revolution wherein gap represents a distance in time between the failing edge of a target device and the next rising edge of the target device.

26. The method as in claim 25, wherein the effect caused by the twist produced by torque transmitted in the shaft will change the difference in size between succeeding gaps by an amount equal to twice the twist produced by the transmitted torque.

27. The method as in claim 17, further comprising: changing the clock rate as a function of shaft speed.

28. The method as in claim 17, further comprising: utilizing a re-circulating ring buffer in which the individual target times of passage are stored, together with a calculation which at each target device passage updates running sums to be consistent with data from the last complete revolution of the shaft leading up to the target device just passed.

29. A computer readable storage medium having stored thereon computer executable program for measuring torque transmitted in a rotating shaft subject to torsional twist using two target devices located at two locations on the shaft, each including one or more reference edges, with two sensors each disposed adjacent to corresponding target device for determining the passage of corresponding reference edge at each location during the rotation of the shaft and generating an electrical signal whose value is altered as the reference edges pass the sensor, the computer program when executed causes a processor to execute steps of:
producing a count value representative of the time between the passing of a said reference edge and a counter reset, said counters being reset in a known relationship;
calculating a difference between the clock times of successive reference edges to produce an actual time elapsed between the passages of the referenced edges by their respective sensors, wherein a change in time difference represents a time proportional to twice the twist of the shaft as a consequence of transmitted torque,
converting the change in time difference into a value that represents a change in the angular orientation of the two target devices with respect to their angular orientation at zero torque, which is substantially equivalent to an angle of twist in the rotating shaft between the target devices, and
calculating the torque transmitted in the rotating shaft based on said change in angle of twist.

30. The computer readable storage medium of claim 29, wherein the computer program when executed causes the processor to further execute step of: determining a sign of the torque being transmitted in the shaft by subtracting a static (zero torque) offset between the two target devices from an absolute value of a relative offset of the two target devices.

31. The computer readable storage medium as in claim 29, wherein the computer program when executed causes the processor to further execute step of: calculating a sum of the times of occurrence of electrical signals with alternate signs over one complete revolution of the shaft.

32. The computer readable storage medium as in claim 29, wherein the computer program when executed causes the processor to further execute step of: calculating the angle of twist from either only rising edges or only falling edges of the target passage signal.

33. The computer readable storage medium as in claim 29, wherein the computer program when executed causes the processor to further execute step of: calculating the torque based on the change in angle of twist, stressed distance between the target devices and the shaft's stiffness.

34. The computer readable storage medium as in claim 29, wherein the computer program when executed causes the processor to further execute step of: calculating a change in a difference between two successive gaps over one complete revolution wherein gap represents a distance in time between the falling edge of a target device and the next rising edge of the target device.

35. The computer readable storage medium of claim 34, wherein the effect caused by the twist produced by torque transmitted in the shaft will change the difference in size between succeeding gaps by an amount equal to twice the twist produced by the transmitted torque.

36. The computer readable storage medium as in claim 29, wherein the computer program when executed causes the processor to further execute step of: utilizing a re-circulating ring buffer in which the individual target times of passage are stored, together with a calculation which at each target device passage updates running sums to be consistent with data from the last complete revolution of the shaft leading up to the target device just passed.
